(19) United States
(12) Patent Application Publication
(10) Pub. No.: US 2002/0020020 A1
(43) Pub. Date: Feb. 21, 2002

(54) Pain management pillow and methods for using same

(76) Inventor: Joseph DeMarco, Sewell, NJ (US)

Correspondence Address: Michael K. Jones, WOODCOCK WASHBURN LLP, One Liberry Place - 46th Floor, Philadelphia, PA, 19103, US

(21) Appl. No.: 09/981,590

(22) Filed: Oct. 17, 2001

Related U.S. Application Data
(63) Continuation-in-part of application No. 29/109,254, filed on Aug. 4, 1999, now abandoned.

(51) Int. Cl. B68G 5/00; A47C 20/02

(52) U.S. Cl. 5/652

(57) ABSTRACT

Pillows for use by patients to help ease the pain in the thoracic, abdominal, pelvic, and flank areas originating from a variety of causes including for example, surgical incisions and stitches; internal and external injuries or bruises, such as bruised or fractured ribs; and natural body aches, such as menstrual cramps. The pillow is preferably made from resilient closed cell foam and has a handle to assist in placement of the pillow over a region of pain. The pillows can be washed and reused. Disposable or washable covers and heating or cooling packs can be used in conjunction with the pillows of the invention.

### RELATED U.S. APPLICATION DATA

This application is a Continuation-In-Part of Ser. No. 29/109,254, filed Aug. 4, 1999.

### FIELD OF THE INVENTION

The present invention relates generally to a medical pillow. More specifically, the invention relates to a pain management pillow that can be used by a patient to help ease pain and discomfort in the trunk area of the body.

### BACKGROUND OF THE INVENTION

After surgery, patients often have difficulty breathing and coughing due to the pain and discomfort that results from an expanding and contracting body trunk area that pulls on the surgical incision and stitches. The expansion and contraction of the incision can cause the wound to open or tear the stitches.

U.S. Pat. No. 4,829,613 discloses a protective pad for patients recovering from heart surgery. The utility of the protective pad is limited because it is specifically designed for cardiac surgery.

U.S. Pat. No. 4,683,601 discloses a medical pillow that can be used for pain management. The utility of the medical pillow is limited because the wing-like members make it cumbersome for a patient to use and it is relatively expensive to manufacture.

U.S. Pat. No. 5,154,691 discloses a sling that is used for pain management. The utility of the sling is limited because the patient's comfort is compromised unnecessarily by the sling, which must be worn at all times and is relatively expensive to manufacture.

The above devices are all further limited in their utility because they employ “stuffing material” in similar fashion to a customary pillow. The use of stuffing material is not well suited for applying uniform pressure, does not retain its shape, and is susceptible to sanitization problems. Furthermore, the above devices are constructed specifically for managing pain following surgical procedures and do not address the needs of patients suffering from other sources of pain, such as broken ribs and menstrual cramps.

Therefore, a need exists for an apparatus to help manage pain in a patient's trunk area that is cost effective to manufacture, easy to use and clean, firm and resilient, and available in a variety of shapes and sizes to fit a patient's particular needs.

### SUMMARY OF THE INVENTION

The present invention provides pillows that include a body comprising a resilient, non-absorbent material having a top surface, a contact surface, and at least one side wall extending between said top surface and said contact surface; and a handle comprising at least one support that connects an outer portion of said handle to said top surface. In certain embodiments, the pillows of the invention conform to a portion of the human trunk area, are semi-rigid, and are formed from a closed cell foam material.

Also provided are methods for using the pillows of the invention. In one aspect, these methods comprise placing the contact surface of the pillow body upon a portion of a human trunk area (in contact with skin and/or a garment) and applying pressure to the top surface of the pillow. In preferred embodiments, the trunk area upon which the pillow is placed bears a sutured surgical incision. Once the pillow is positioned, the patient typically coughs, and optimally experiences less pain in doing so due to the presence of the pillow and the pressure applied thereto.

The present invention thus allows for standardization of treatment and pain relief in the trunk area caused by surgical incisions, injuries, and cramps. The pillow handle facilitates placement anywhere on the thoracic, abdominal, pelvic, and flank areas for many different types of pain. Furthermore, the invention is made from a resilient, non-absorbent material that can be washed and reused by the patient.

The invention can be manufactured in a variety of shapes and sizes to suit the patient's body size and area of pain. The invention can also have the surface in contact with the patient's body contoured to better conform to the curvature of the patient's body.

The handle can include a hook-type handle, a loop-type handle, or the like. The hook-type handle has a single support connecting the outer portion of the handle to the top surface. The loop-type handle has multiple supports connecting the outer portion of the handle to the top surface. A hook-type handle will not block the flow of intravenous needles, nor will it block the medical staff's view of the intravenous needles. A loop-type handle encircles the hand making handling and placement of the pillow easier.

In addition, the pillow can include a heating or cooling pack. This embodiment provides additional comfort and treatment for the patient by incorporating a means for holding a heating or cooling pack over the region of pain. The heating or cooling pack can be placed within a cavity of the pillow between the pillow and the patient's body.

Furthermore, the pillow can include a removable portion to fill in the cavity. The removable portion can be removed by the patient or caretaker to expose the cavity for placement of the heating or cooling pack allowing the pillow to be used both with and without a heating or cooling pack.

In another embodiment, the pillow can include a replaceable cover to facilitate cleaning. The cover is preferably made from either a washable or disposable fabric, such as commonly used in other disposable medical devices.

The disposable covers can also be designed to provide a means for placement of a heating or cooling pack adjacent to the patient's body. The cover can be designed with an additional pocket specifically for the heating or cooling pack, or the heating or cooling pack can be placed between the cover and the contact surface of the invention.

Other features of the invention are described below.

### BRIEF DESCRIPTION OF THE DRAWINGS

The foregoing and other features and advantages of the present invention will be more clearly understood from the following drawings which represent non-limiting examples of the invention and wherein the different figures represent:

FIG. 1 is an illustrative view of an exemplary pain management pillow with a loop-type handle being used by a patient;

FIG. 2 is a top view of the pain management pillow of FIG. 1 being used by a patient;

FIG. 3 is a perspective view of the pain management pillow of FIG. 1;

FIG. 4 is an illustrative view of an exemplary larger pain management pillow with a loop-type handle being used by a patient;

FIG. 5 is an illustrative view of an exemplary rectangular pain management pillow with a hook-type handle being used by a patient with an intravenous needle in his hand;

FIG. 6A is a side view of an exemplary pain management pillow having a flat contact surface and loop-type handle;

FIG. 6B is a side view of an exemplary pain management pillow having a contoured contact surface with a planar tapered surface and hook-type handle;

FIG. 6C is a side view of an exemplary pain management pillow having a contoured contact surface with a curved tapered surface;

FIG. 7A is a cross-sectional view of a pain management pillow having a cover;

FIG. 7B is a cross-sectional view of a pain management pillow showing a heating or cooling pack disposed in a cavity;

FIG. 7C is a cross-sectional view of a pain management pillow showing a heating or cooling pack disposed between the contact surface and a cover;

FIG. 7D is a cross-sectional view of a pain management pillow showing a heating or cooling pack disposed within a pocket formed in the cover;

FIG. 8 is a bottom view of another exemplary pain management pillow showing the contact surface and cavity; and

FIG. 9 is a perspective view of the bottom of another exemplary pain management pillow showing the contact surface, cavity, and removable portion.

### DETAILED DESCRIPTION OF THE INVENTION

The pain management pillow 1 helps patients manage pain and discomfort within the trunk area 17 of the body. The trunk area 17 includes the thoracic, abdominal, pelvic, and flank areas. The patient's pain or discomfort in the trunk area 17 can originate from a variety of causes including, for example, surgical incisions and stitches, injuries and bruises, both internal and external, and natural body aches, such as menstrual cramps, for example.

The region of pain is the area within the trunk area 17 that the patient experiences pain or discomfort. The patient's pain or discomfort can be exasperated by any movement within the patient's trunk area. The movement can be caused by the expansion and contraction of the trunk area caused by breathing or coughing. Applying pressure to the region of pain reduces movement within the trunk area, and therefore, reduces the level of pain experienced by the patient.

The region of pain will vary from patient to patient, and will depend on the cause of pain or discomfort. The region of pain can vary in both the horizontal X and vertical Y directions. For example, following heart surgery, the region of pain can be larger and will likely be located over the center of the thoracic area, while following abdominal surgery, the region of pain can be smaller and can be located more to one side of the patient. Similarly, an adult with bruised ribs can have a larger region of pain compared to a child with bruised ribs.

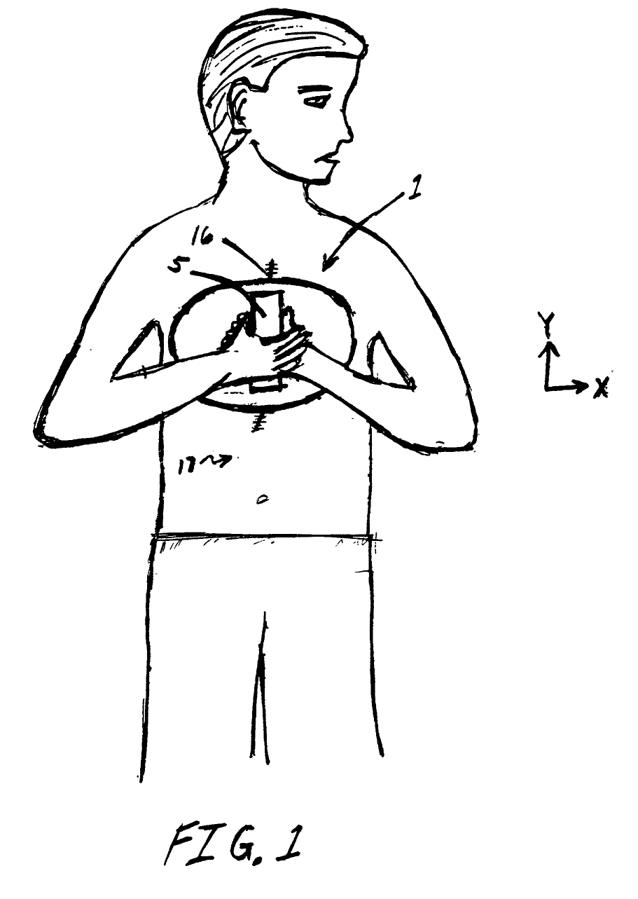

FIG. 1 shows an exemplary pain management pillow 1 being used by a patient. As shown in FIG. 1, a patient's source of pain or discomfort can be an incision site 16 in the trunk area 17. The patient's region of pain will likely be centered over the incision site 16 and will extend over the area where the patient senses pain or discomfort.

When a patient senses the onset of pain or discomfort, such as a pending cough, the patient will use the handle 5 to place the pain management pillow 1 in contact with the region of pain. The patient then manually exerts pressure on the region of pain by exerting pressure on the pain management pillow 1 toward the region of pain. When the pain or discomfort subsides, the patient can remove the pain management pillow 1 from his or her trunk area 17 and set it aside for future use.

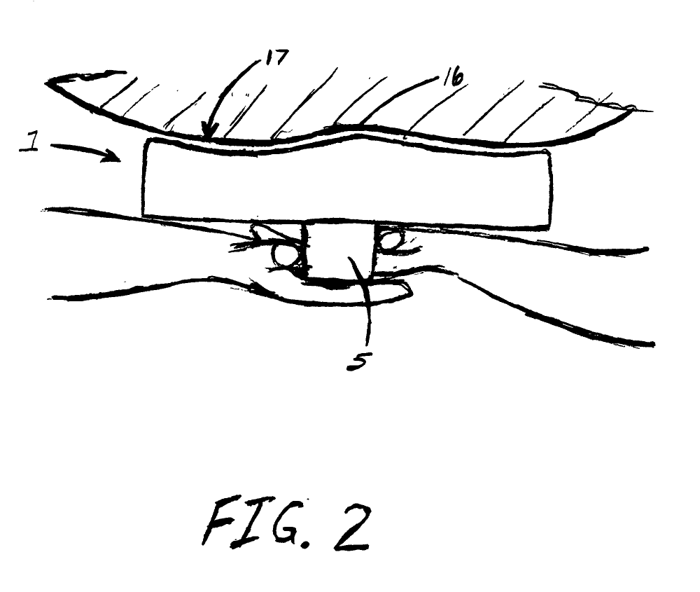

FIG. 2 shows a top view of the pain management pillow 1 of FIG. 1. As shown in FIG. 2, the pain management pillow 1 is in contact with the region of pain within the trunk area 17 of the body.

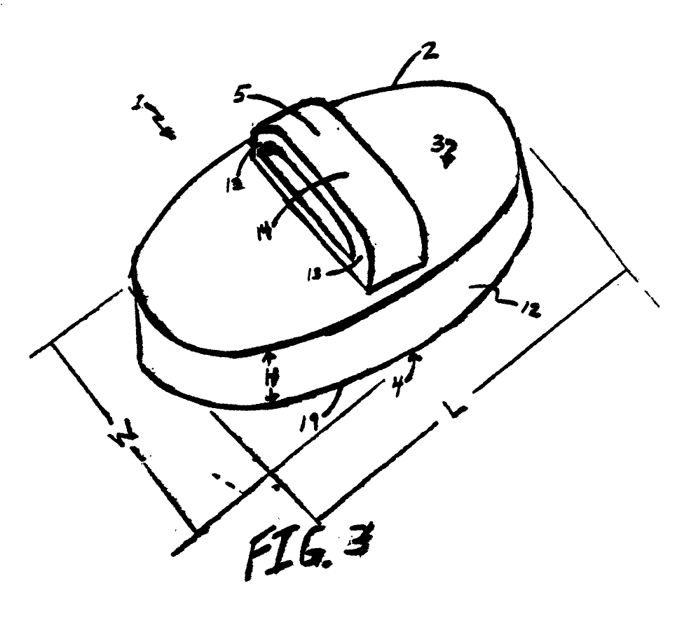

FIG. 3 shows a perspective view of one embodiment of the pain management pillow 1 including a body 2 and a handle 5. As shown in FIG. 3, the body 2 includes a top surface 3, a contact surface 4, and at least one side wall 12 extending therebetween. The handle 5 is attached to the body 2 on the top surface 3. In use, the pain management pillow 1 is oriented by the patient such that the contact surface 4 adjoins the region of pain.

The body 2 is made from a preformed material that allows the body 2 to define and maintain a three-dimensional shape. The preformed body 2 has a length L, a width W, and a height H. The use of a preformed body 2 eliminates the need for a covering over the body 2 to maintain the body's shape.

Preferably, the body is made from a resilient material that conforms to the small contours of the trunk area 17 during use and returns to its original shape after use. Furthermore, the body 2 is preferably made from a resilient non-absorbent material. In one preferred embodiment, the body is made from a resilient, non-absorbent, closed cell foam. The use of a resilient, non-absorbent, closed cell foam allows the pain management pillow 1 to be easily washed and reused. Furthermore, the foam is preferably semi-rigid such that the force exerted by the patient onto the top surface 3 or handle 5 is distributed fairly uniformly across the contact surface 4. The body can be made from other materials having the desired characteristics of resiliency, non-absorption, and the capability of being preformed to a three dimensional shape, such as, for example, a rubber material.

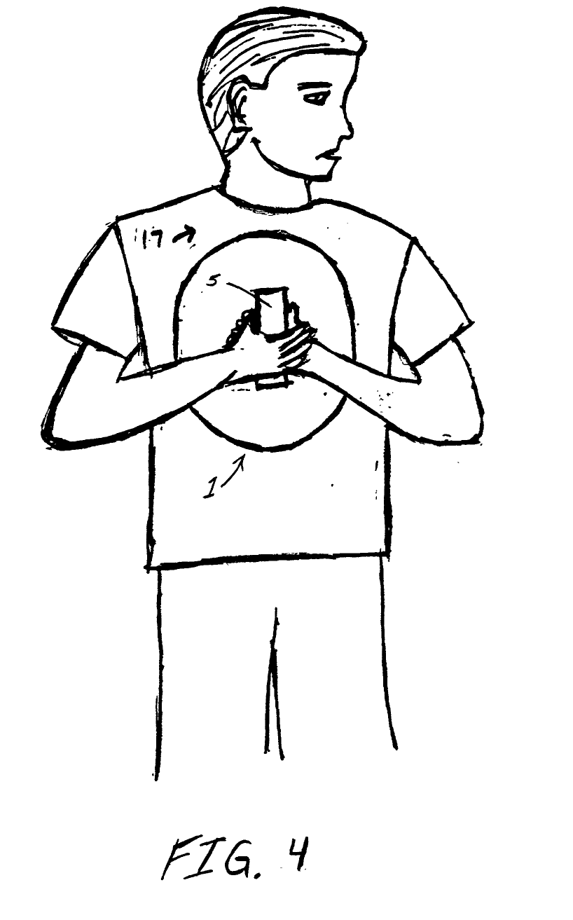

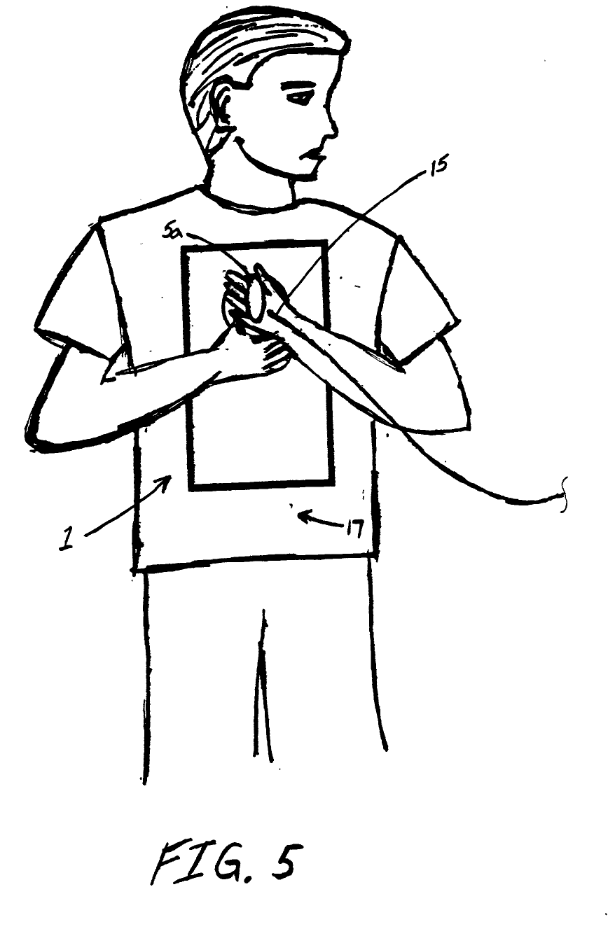

FIG. 4 shows an exemplary larger pain management pillow 1 with an oval shape being used by a patient. FIG. 5 shows an exemplary larger pain management pillow 1 with a rectangular shape being used by a patient. The size and shape of the pain management pillow 1 can vary depending on the region of pain, the size of the patient, and the like. Preferably, the size and shape of the pain management pillow 1 is generally congruent to the region of pain.

The size of the pain management pillow 1 can vary from about 5 inches to about 13 inches in both length L and width W dimensions. As shown in FIG. 1, the orientation of the handle 5 can be perpendicular to the length L. Alternatively, as shown in FIGS. 4 and 5, the orientation of the handle 5 can be parallel to the length L. The length and width can also be equal, such as a square or circle shape.

The shape of the pain management pillow can be circular, square, rectangular, oval, etc. FIGS. 1 and 4 show exemplary pain management pillows 1 with an oval shape. FIG. 5 shows an exemplary pain management pillow 1 with a rectangular shape.

In addition to varying the size and shape of the pain management pillow 1 to conform to the area of the region of pain, the size and shape can also be varied to improve overall patient comfort. For example, to help reduce breast discomfort, a female patient may prefer a pain management pillow 1 having a circular or oval shape rather than a rectangular shape.

As shown in FIG. 3, in one preferred embodiment, the handle 5 is a loop-type handle. The loop-type handle 5 has at least two supports 13 that connect the outer portion 14 of the handle 5 to the top surface 3. The loop-type handle 5 eases placement and removal of the pain management pillow 1 by encircling the patient's hand. With the patient's hand encircled, the loop-type handle 5 reduces or eliminates any grasping effort that can be required by the patient.

The loop-type handle 5 can be made from either a pliable or rigid material because it has more than one support 13 connecting the outer portion 14 of the handle 5 to the top surface 3. Preferably, the handle 5 is made from a material that allows the handle 5 to be preformed to a defined three-dimensional loop shape, allowing the patient to easily insert his or her hand. The material is preferably semi-rigid, such that the handle 5 retains its shape but does not cause discomfort or injury to the patient.

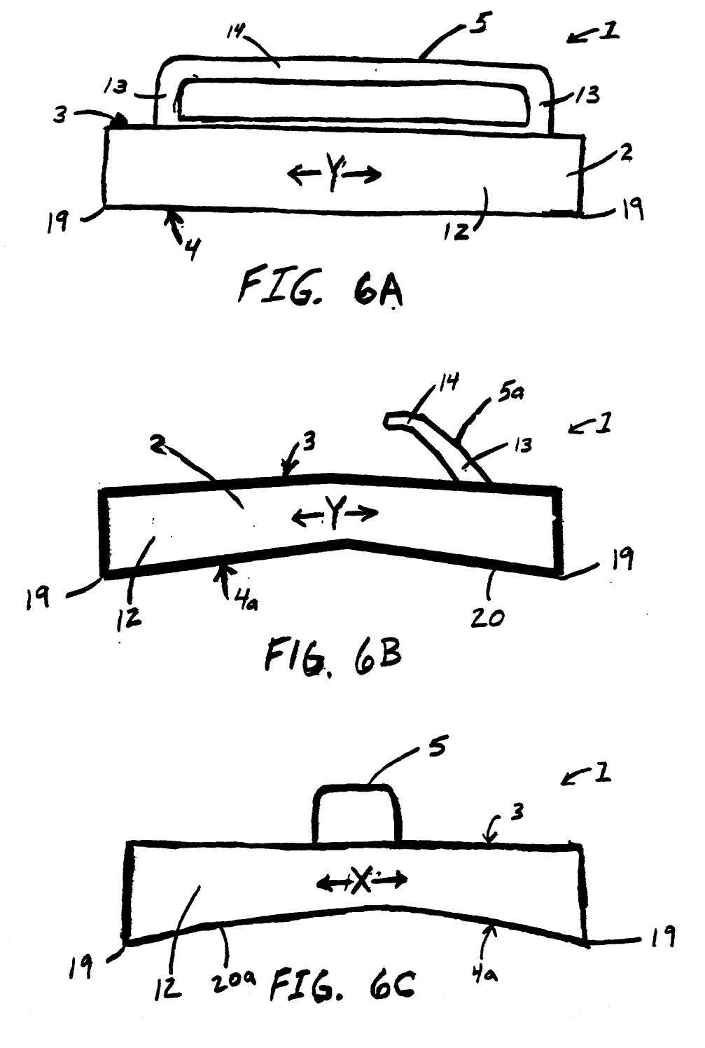

FIG. 6A shows a side view of an exemplary pain management pillow 1 having a flat contact surface 4 with a loop-type handle 5. FIG. 6B shows a side view of another exemplary pain management pillow 1 having a contoured contact surface 4a and a hook-type handle 5a. As shown in FIG. 6B, a hook-type handle 5a has one support 13 connecting the outer portion 14 of the handle 5a to the top surface.

Depending on the patient's particular needs, a hook-type handle 5a with a single support 13 can be preferred because, as shown in FIG. 5, the hook-type handle 5a only partially covers the hand. By leaving a portion of the hand exposed, the hook-type handle 5a will not interfere with the flow of an intravenous needle 15, nor will it block the medical staff's view of an intravenous needle 15. The hook-type handle 5a is preferably made from a soft and pliable yet sturdy material because it has only one support 13 connecting the outer portion 14 of the handle 5 to the top surface 3. The material used for the hook-type handle 5a should be sturdy enough to support the pain management pillow 1 during handling but soft enough to prevent discomfort or injury to the patient.

The size of the handle 5 can vary to accommodate the needs of the particular patient. For example, an adult with large hands may require a larger handle compared to a child with smaller hands.

As shown in FIGS. 6A-6C, in addition to varying the size and shape of the body 2, the contour of the contact surface 4 can be flat or contoured to improve fit and comfort. The contoured design has the contact surface 4a shaped to better conform to the curvature of the patient's region of pain within the trunk area 17. The area of contact between the contact surface 4a and the region of pain with the contoured design is increased and pressure against the region of pain during use is more uniform.

As shown in FIGS. 6B and 6C, the contoured contact surface 4a includes a tapered surface 20 that tapers from a lower edge 19 of the side wall 12 towards the center of the contoured contact surface 4a. The tapered surface 20 can be a flat or planar surface, as shown in FIG. 6B. Alternatively, the tapered surface 20 can include a curved surface to form a curved tapered surface 20a, as shown in FIG. 6C.

Preferably, the tapered surface 20 extends from opposite sides of the side wall 12 such that the contoured contact surface 4a is tapered on one axis. The tapered surface axis can be designed to be placed vertically Y on the trunk area 17, as the exemplary pain management pillow 1 in FIG. 6B illustrates. Alternatively, the tapered surface axis can be designed to be placed horizontally X on the trunk area 17, as the exemplary pain management pillow in FIG. 6C illustrates. In yet another exemplary embodiment, the tapered surface 20 can extend from the lower edge 19 around the perimeter of the side wall 12, such that the center of the contoured contact surface 4a is generally concave and forms a dish-like contoured contact surface 4 (not shown).

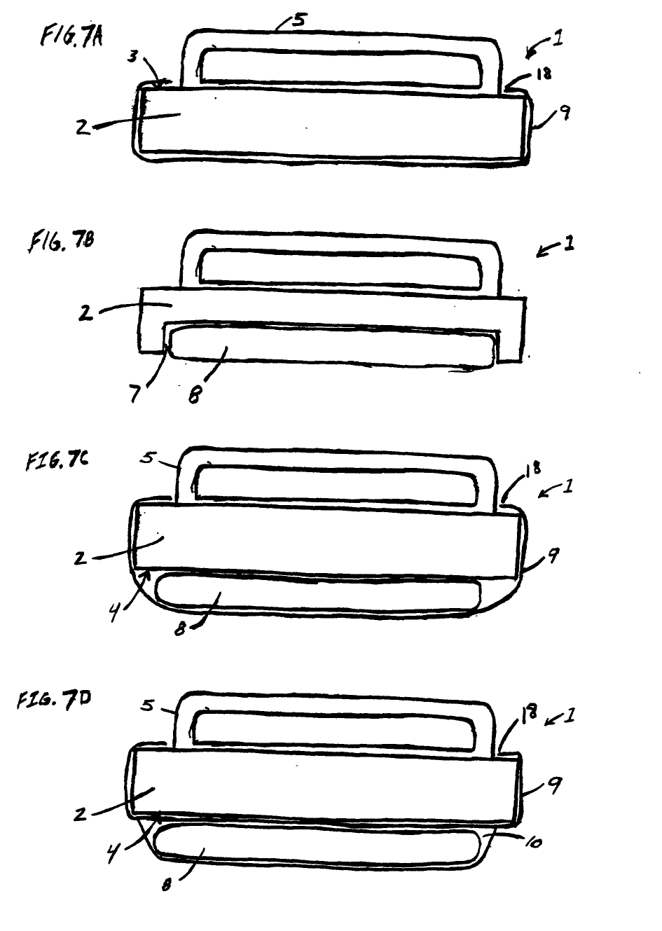

FIG. 7A shows a cross-sectional view of an exemplary pain management pillow 1 with a cover 9. The use of a cover 9 facilitates cleaning of the pain management pillow 1. The cover 9 generally envelops the body 2 and can be removed and replaced in a similar fashion to conventional pillowcases.

Unlike a pillowcase, however, the cover 9 preferably has a hole 18 on the surface nearest the top surface 3 to allow the handle 5 to protrude through the cover 9. Preferably, the cover 9 can be made from fabrics that are washable or disposable, such as those commonly used in other disposable medical devices.

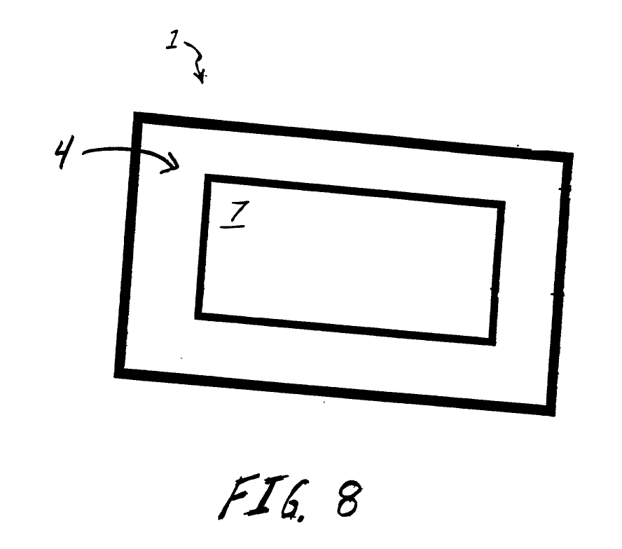

FIGS. 7B and 8 show a view of an exemplary pain management pillow 1 with a cavity 7 that facilitates the use of a heating or cooling pack 8. The use of a heating or cooling pack 8 can provide additional comfort and treatment for the patient. Preferably, the pain management pillow 1 is used in conjunction with a heating pack 8 when a patient with menstrual cramps realizes greater relief by applying heat and pressure against the region of pain.

As shown in FIGS. 7B and 8, one option for incorporated a heating or cooling pack 8 is to construct the body 2 with a cavity 7 on the contact surface 4 in which a heating or cooling pack 8 can be inserted. During use, the heating or cooling pack 8 is contained within the pain management pillow 1 when the heating or cooling pack 8 and surrounding contact surface 4 is placed against the patient's region of pain. A pain management pillow 1 with a cavity 7 can also incorporate a cover 9 to help retain the heating or cooling pack 8 within the cavity 7.

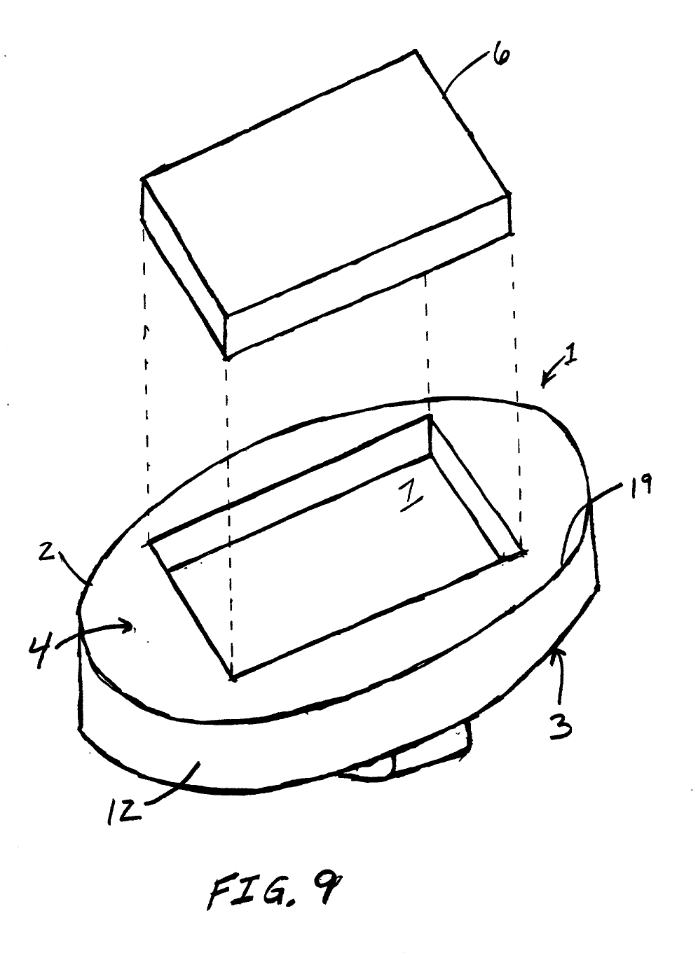

The cavity 7 can be permanent and limit the use of the pain management pillow 1 to use with a heating or cooling pack 8. Alternatively, the cavity 7 can be created by removing a removable portion 6, as shown in FIG. 9. The removable portion 6 can be removed and reinserted into the cavity 7 allowing the same pain management pillow 1 to be used with or without a heating or cooling pack 8.

FIG. 7C shows a cross-sectional view of an exemplary pain management pillow 1 with a cover 9 and a heating or cooling pack 8. As shown in FIG. 7C, another option for incorporating the use of a heating or cooling pack 8 with the pain management pillow 1 is to place the heating or cooling pack 8 between the cover 9 and the contact surface 4. The cover 9 helps retain the heating or cooling pack 8 during removal and placement of the pain management pillow 1 onto the region of pain. As previously disclosed, the cover 9 also facilitates cleaning.

As previously disclosed, when a pain management pillow 1 is used with a cover 9, a cavity 7 is not required to contain the heating or cooling pack 8. However, the contact surface 9 will no longer come into contact with the patient. The surface area on the face of the heating or cooling pack 8 will determine the effective contact area with the patient's region of pain.

FIG. 7D shows a cross-sectional view of an exemplary pain management pillow 1 with a heating or cooling pack 8 disposed within a pocket 10 formed in the cover. As shown in FIG. 7D, the pocket 10 is incorporated into the cover 9 and helps maintain positioning of the heating or cooling pack 8.

The present invention will be further clarified by the following examples which are intended to be purely exemplary of the invention. An example of a large pain management pillow 1 having an oval shaped body 2 includes a length L of about 13 inches, a width W of about 11 inches, and height H of about 1½ inches. An example of a small pain management pillow 1 having an oval shaped body 2 includes a length L of about 7 inches, a width W of about 5 inches, and a height H of about 1½ inches. Varying sizes between the exemplary large and small pain management pillow 1 dimensions are also exemplary of the invention.

Although the above description included representative uses for the pain management pillow 1, the source of the patient's pain and discomfort are not so limited. The patient's pain or discomfort in the trunk area can originate from a variety of causes including, for example, surgical incisions and stitches, injuries and bruises, both internal and external. The patient's pain or discomfort can also originate from natural body aches such as, for example, menstrual cramps, etc. Representative medical procedures and conditions causing pain and discomfort in the trunk area include: excision of tumor from the abdomen, flank or chest; removal of a foreign body from the abdomen, flank or chest; thoracoscopy; excision of pericardial cyst, tumor, or mass; lobectomy; thoracic symapathectomy; repair of lung hernia; lung transplant; pericardiectomy; cardiac tumor; repair of cardiac wound; valvuloplasty with cardiopulmonary bypass; coronary bypass; coronary endarterectomy; cardiac anomalies; thoracic aortic aneuryms; pulmonary artery repairs; heart lung transplantation; nissen fundoplasty; gastrotomy; colostomy; colectomy; laparoscopy of the abdoman, chest or flank; appendiceal abscess; appendectomy; laparotomy; cholecystectomy; laparoscopic cholecystectomy; pancreatectomy; exploratory laparotomy; laparoscopic fulguration or excision of lesion of ovary, pelvic viscera or peritoneal; hernia repair; nephrostomy; renal biopsy; renal transplantation; nephropathy; laparposcopic nephrectomy; renal cyst; cystotomy; laparoscopy hysterectomy; hysterectomy; lysis of adhesions; salpingostomy; ovarian cystectomy; and the like.

It is to be understood that even in the numerous characteristics and advantages of the present invention set forth in the foregoing description and examples, together with details of the structure and function of the invention, the disclosure is illustrative only, and changes can be made to detail, especially in matters of shape, size and arrangement of parts within the principles of the invention to the full extent indicated by the broad general meaning of the terms in which the appended claims are expressed.

What is claimed is:

1. A pillow comprising:
a body comprising a resilient, non-absorbent material having a top surface, a contact surface, and at least one side wall extending between said top surface and said contact surface; and
a handle comprising at least one support that connects an outer portion of said handle to said top surface.

2. The pillow of claim 1, wherein said body comprises a closed cell foam material.

3. The pillow of claim 1, wherein said body is semi-rigid.

4. The pillow of claim 1, wherein said body is sized to be congruent with a region of pain.

5. The pillow of claim 1, wherein said body is shaped to be congruent with a region of pain.

6. The pillow of claim 1, wherein said body shape is square, rectangular, circle, or oval.

7. The pillow of claim 1, wherein said body has a generally oval shape and said handle is a loop-type handle.

8. The pillow of claim 1, wherein said handle is a hook-type handle comprising one support that connects an outer portion to said top surface.

9. The pillow of claim 1, wherein said handle is a loop-type handle comprising two supports that connect an outer portion to said top surface.

10. The pillow of claim 1, wherein said contact surface further comprises a contoured contact surface.

11. The pillow of claim 10, wherein said contoured contact surface comprises a planar tapered surface.

12. The pillow of claim 10, wherein said contoured contact surface comprises a curved tapered surface.

13. The pillow of claim 1, further comprising a cavity in said contact surface of said body for receiving a heating or cooling pack therein.

14. The pillow of claim 13, further comprising a removable portion that can be removed and replaced from said cavity of said body.

15. The pillow of claim 13, further comprising a removable cover that envelops at least a portion of said body.

16. The pillow of claim 1, further comprising a removable cover that envelops at least a portion of said body.

17. The pillow of claim 16, wherein said cover includes a hole through which said handle protrudes.

18. The pillow of claim 16, wherein said cover includes a pocket that is configured to receive a heating or cooling pack.

19. An apparatus comprising:
a semi-rigid oval shaped body comprising a resilient, non-absorbent, closed cell foam with a top surface, a contact surface with a length of about 7 to about 13 inches and a width of about 5 to about 11 inches, one side wall about one to two inches high extending between said top surface and said contact surface; and
a loop-type handle comprising two supports that connect an outer portion of said handle to said top surface.

20. The apparatus of claim 19, further comprising a removable cover that envelops at least a portion of said body.

21. The apparatus of claim 19, further comprising a cavity in said contact surface of said body that is configured to receive a heating or cooling pack.

22. A method comprising the steps of:
providing a piece of resilient closed cell foam to form a body having a top surface, a contact surface and at least one side wall extending between said top surface and said contact surface; and
attaching a handle to said top surface of said body.

23. A method comprising the steps of:
providing a device according to claim 1;
placing said contact surface of said body of said device upon a region of pain within a trunk area of a human; and
applying pressure over said top surface of said device.

23. The method of claim 23 wherein said trunk area bears a sutured surgical incision.

24. The method of claim 23 further comprising instructing said human to cough.

25. The method of claim 23 wherein said pressure is applied by said human.

26. The method of claim 25 further comprising coughing.
